(19) United States
(12) Patent Application Publication
(10) Pub. No.: US 2015/0370923 A1
(43) Pub. Date: Dec. 24, 2015

(54) System and Methods of Generating a Computer Model of a Composite Component

(71) Applicant: General Electric Company, Schenectady, NY (US)

(72) Inventors: Teresa Tianshu Chen-Keat, Niskayuna, NY (US); Pinghai Yang, Niskayuna, NY (US); Li Zheng, Niskayuna, NY (US); Haifeng Zhao, Katy, TX (US); Nicholas Joseph Kray, Blue Ash, OH (US)

(21) Appl. No.: 14/308,135

(22) Filed: Jun. 18, 2014

(51) Int. Cl. G06F 17/50; G06T 17/00

(52) U.S. Cl. CPC G06F 17/50; G06T 17/00

(57) ABSTRACT

A computer-implemented method for generating a computer model of a composite component includes offsetting a projected ply curved surface outwardly along a base surface to define an offset ply curved surface. The method also includes defining a ply drop region of the base surface, the ply drop region includes another area of the base surface that is exterior to a ply curved surface and interior to an offset ply curved surface. A surface mesh is generated based on the ply drop region and the ply curved surface. The method includes generating a node data comprising a plurality of node points relative to the ply drop regions. Moreover, the method includes applying a curved function to the plurality of node points to facilitate forming a smoothed node data across the ply drop region. A ply mesh is generated using the smoothed node data and the surface mesh.

### BACKGROUND

The embodiments described herein relate generally to computer modeling, and more particularly, to systems and methods for generating a computer model of a composite component having a plurality of composite plies.

Composite laminate components generally include a plurality of layers or plies of composite material assembled together to provide the composite component with improved engineering properties. Composite components are typically manufactured by assembling a plurality of plies one on top of the other within a suitable tool or mold until a required thickness and shape is achieved. However, depending on the desired configuration of the component being manufactured, it may be necessary to taper the thickness of the plies. For example, thickness tapering may be required to create a component having a desired surface contouring or shape. To provide such thickness tapering, one or more shortened or terminated plies are typically introduced at various locations within the laminate to form ply drops. Each ply drop generally represents a step-reduction in the thickness of the laminate, thereby permitting a laminate material to taper from a thicker cross-section to a thinner cross-section.

The ply drops should be organized and represented on a computer ply model for subsequent manufacturing in order to lay-up and manufacture the composite component. In the design stage of the composite components, computer aided design (“CAD”) models of the ply drops are sometimes generated. A typical CAD system may allow a user to construct and manipulate complex three dimensional (3D) models of objects or assemblies of objects. Moreover, the CAD system may provide a representation of modeled objects using edges or lines, which may be represented in various manners, e.g., non-uniform rational B-splines. These systems may manage parts or assemblies of parts as modeled objects, which typically include specifications of geometry. More particularly, computer aided files contain specifications, from which geometry is generated, which in turn allow for a representation to be generated, such that the systems include graphic tools for representing the modeled objects to the designers.

Current CAD systems provide an approximate representation of the ply surface, ply boundary, and associated curved or contoured surfaces. Conventional CAD systems, however, may not provide a direct method to generate the ply-by-ply definition for CAD modeling and may not represent realistic ply drops to effectively and accurately design ply drops. Moreover, some computer models are limited to non-smoothed or discretized ply mesh patterns which are biased away from real ply geometry. Current computer models may produce mesh patterns with misleading numerical outcomes generated by the CAD modeling. Moreover, manufacturing processes for the physical composite component based on a typical 3D computer model may lead to lay-up issues for the composite laminates since discretized areas may not be properly defined in the modeling stage. Inaccurate computer modeling may lead to machine tool head collision with the composite laminate and/or an undesired tool path generation.

### BRIEF DESCRIPTION

In one aspect, a computer-implemented method for generating a computer model of a composite component includes offsetting a projected ply curved surface outwardly along a base surface to define an offset ply curved surface. The method also includes defining a ply drop region of the base surface. The ply drop region includes another area of the base surface that is exterior to a ply curved surface and interior to an offset ply curved surface. The method further includes generating a surface mesh based on the ply drop region and the ply curved surface. The method also includes generating a node data comprising a plurality of node points relative to the ply drop regions. The method further includes applying a curved function to the plurality of node points to facilitate forming a smoothed node data across the ply drop region. The method also includes generating a ply mesh using the smoothed node data and the surface mesh.

In another aspect, a computer device for generating a computer model of a composite component having a base surface, a ply curved surface, and plurality of composite plies includes a memory device configured to store a characteristic of the composite component. The computer device also includes an interface coupled to the memory device and configured to receive the characteristic of the composite component. The computer device further includes a processor coupled to the memory device and the interface device. The processor is programmed to offset the projected ply curved surface outwardly from the base surface to define an offset ply curved surface. The processor is also configured to define a ply region of the base surface. The ply region includes an area of the base surface that is interior to the ply curved surface. The processor is further configured to define a ply drop region of the base surface. The ply drop region includes another area of the base surface that is exterior to the ply curved surface and interior to the offset ply curved surface. The processor is also configured to generate a surface mesh based on the ply drop region and the ply curved surface. Further, the processor is configured to generate a node data comprising a plurality of node points relative to the ply drop regions. The processor is also configured to apply a curved function to the plurality of node points to facilitate forming a smoothed node data across the ply drop region. The processor is further configured to generate a ply mesh using the smoothed node data and the surface mesh.

In a further aspect, one or more non-transitory computer-readable media having computer-executable instructions embodied thereon for generating a computer model of a composite component having a base surface, a ply curved surface, and a plurality of composite plies uses a computer having a memory device and a processor, wherein when executed by the processor, the computer-executable instructions cause the processor to offset the projected ply curved surface outwardly from the base surface to define an offset ply curved surface. The computer-executable instructions also cause the processor to define a ply region of the base surface. The ply region includes an area of the base surface that is interior to the ply curved surface. The computer-executable instructions further cause the processor define a ply drop region of the base surface. The ply drop region includes another area of the base surface that is exterior to the ply curved surface and interior to the offset ply curved surface. The computer-executable instructions also cause the processor to generate a surface mesh based on the ply drop region and the ply curved surface. The computer-executable instructions cause the processor to generate a node data comprising a plurality of node points relative to the ply drop regions. The computer-executable instructions further cause the processor to apply a curved function to the plurality of node points to facilitate forming a smoothed node data across the ply drop region. The computer-executable instructions also cause the processor to generate a ply mesh using the smoothed node data and the surface mesh.

Still further, in one aspect, a computer-implemented method for generating a computer model of a composite component having a predefined base surface, a ply region, and a ply drop region includes defining a symmetrical cross section on a plane of symmetry of the composite component. The method also includes generating a surface mesh template based at least on one of the ply region and the ply drop region. The method further includes generating a two-dimensional surface relative to the base surface. The method also includes defining a mesh element comprising a plurality of node points relative to the ply region and the ply drop region. The method further includes applying a curved function to the plurality of node points to facilitate forming a smoothed node data across the ply drop region and along the symmetrical cross section. The method also includes generating a smoothed cross section mesh. Further, the method includes generating a three-dimensional mesh by extruding the smoothed cross section mesh.

### DRAWINGS

These and other features, aspects, and advantages will become better understood when the following detailed description is read with reference to the accompanying drawings in which like characters represent like parts throughout the drawings, wherein:

FIG. 1 is a plan view of an exemplary composite component having a base surface and a plurality of composite plies arranged in a spaced relationship with respect to the base surface;

FIG. 2 is a schematic view of an arrangement of the plurality of composite plies of the composite component shown in FIG. 1;

FIG. 3 is schematic view of another arrangement of the plurality of composite plies shown in FIG. 1;

FIG. 4 is a side elevational view of an arrangement of the plurality of plies shown in FIG. 3;

FIG. 5 is a block diagram illustrating an exemplary system having a computing device for use in computer modeling the composite component shown in FIGS. 1-4;

FIG. 6 is a side elevational view of an exemplary computer model of the composite component shown in FIGS. 1 and 2;

FIG. 7 is a plan view of the exemplary computer model shown in FIG. 6 of the composite component having an exemplary ply drop region;

FIG. 8 is a schematic view of the computer model and discretized ply drop regions associated with the composite component shown in FIG. 1;

FIG. 9 is another schematic view of the computer model and a plurality of node points applied to the discretized ply drop regions shown in FIG. 8;

FIG. 10 is yet another schematic view of the computer model and a curved function applied to the plurality of node points shown in FIG. 9;

FIG. 11 is another schematic view of the computer model and the curved function shown in FIG. 10 being propagated through the ply drop regions shown in FIG. 8;

FIG. 12 is another schematic view of the computer model shown in FIG. 11 and a generated ply mesh;

FIG. 13 is a flowchart illustrating an exemplary computer implemented method of generating a computer model of a composite component;

FIG. 14 is a schematic view of the computer model of a lay-up geometry of the plurality of plies;

FIG. 15 is another schematic view of the computer model of the plurality of plies shown n FIG. 14 subsequent a cure process;

FIG. 16 is a schematic view of an overlay of the computer models shown in FIGS. 14 and 15;

FIG. 17 is a cross sectional view of an exemplary composite component formed by an exemplary manufacturing lay-up sequence;

FIG. 18 is a perspective view of the computer model of composite component;

FIG. 19 is a plan view of the computer model and composite component shown in FIG. 18; and

FIG. 20 is a flowchart illustrating an exemplary computer implemented method of generating a computer model of a composite component.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings. The singular forms “a”, “an”, and “the” include plural references unless the context clearly dictates otherwise. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the term “computer” and related terms, e.g., “computing device”, are not limited to integrated circuits referred to in the art as a computer, but broadly refers to a microcontroller, a microcomputer, a programmable logic controller (PLC), an application specific integrated circuit, and other programmable circuits, and these terms are used interchangeably herein.

Further, as used herein, the terms “software” and “firmware” are interchangeable, and include any computer program stored in memory for execution by personal computers, workstations, clients and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

The embodiments described herein relate to a system and methods of generating computer models of composite components using a mathematical basis spline analysis (“B-spline analysis”). More particularly, the embodiments relate to methods, systems and/or apparatus for generating a three dimensional ply mesh generated by parametrization of the b-surface which represents a ply surface. It should be understood that the embodiments described herein include a variety of types of composite components, and further understood that the descriptions and figures that utilize turbine blades are exemplary only.

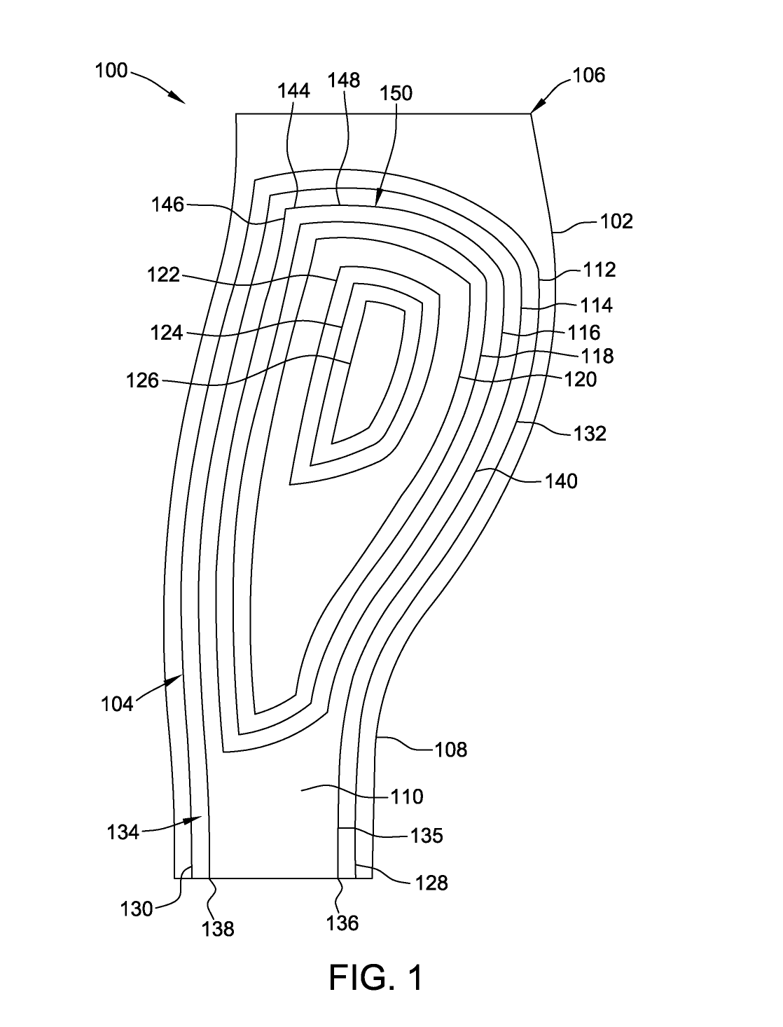

FIG. 1 is a plan view of a composite component 100 having a base surface 102 and a plurality of composite plies 104 arranged in a spaced relationship with respect to base surface 102. In the exemplary embodiment, composite component 100 includes a turbine blade 106. Alternatively, composite component 100 may include other structures such as, but not limited to, vanes, rotors, and stators. Composite component 100 may include any structure having a laminate formation requiring increased strength and stiffness. Base surface 102 includes a perimeter 108 and an internal surface area 110 defined by perimeter 108. Alternatively, base surface 102 may include other cross-sectional areas of composite component 100. The plurality of plies 104 includes a first ply 112, a second ply 114, a third ply 116, a fourth ply 118, a fifth ply 120, a sixth ply 122, a seventh ply 124, and an eighth ply 126. Alternatively, the plurality of plies 104 may include less than eight plies or more than eight plies, i.e., composite component 100 may include any number of plies 104 to enable blade 106 to function as described herein.

In the exemplary embodiment, first ply 112 includes a first end 128, a second end 130 and a body 132 extending there between. First end 128 and second end 130 are configured to couple to base surface 102. More particularly, first end 128 and second end 130 do not couple to each other to facilitate forming an open curved surface 134. Second ply 114 also includes a first end 136, a second end 138, and a body extending 140 there between. First end 136 and second end 138 are coupled to base surface 102 at perimeter 108 to form another open curved surface 135. Third ply 116 includes a first end 144, a second end 146, and a body 148 extending there between. In the exemplary example, first end 144 and second end 146 are coupled to each other to facilitate forming a closed curved surface 150. Fifth ply 120, sixth ply 122, seventh ply 124 and eighth ply 126 further include respective first ends 144, second ends 146, and bodies 148 (not shown for clarity) extending there between. First ends 144 and second ends 146 of fourth ply 118, fifth ply 120, sixth ply 122, seventh ply 124 and eighth ply 126 are further coupled to each other to form other closed curved surfaces 150 (not shown for clarity). Plies 104 can include any open and/or closed surfaces to enable composite component 100 to function as described herein.

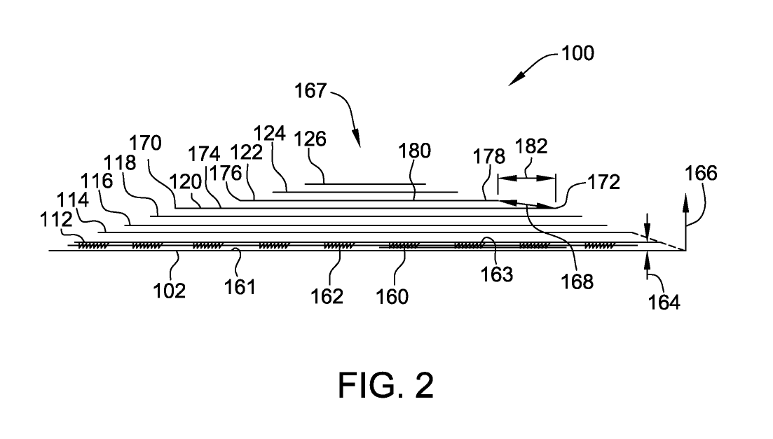

FIG. 2 is a schematic view of an arrangement of the plurality of plies 104 of composite component 100. In the exemplary embodiment, composite component 100 includes an ascending arrangement of plies, 112, 114, 116, 118, 120, 122, 124, and 126 as referenced from base surface 102. More particularly, each subsequent ply 104 has a shorter length than a previous ply 104. Each ply 104 includes a plurality of fibers 160 (fibers 160 only shown for first ply 112 for clarity purposes) surrounded by and supported within a matrix resin 162 (matrix resin 162 only showed for first ply 112 for clarity purposes). Fibers 160 are unidirectional and orientated within each ply 104 in a longitudinal direction of component 100. Alternatively, fibers 160 may be multi-directional and orientated within each ply 104 in lateral direction of composite component 100. Each ply 104 includes a ply thickness 164 as measured between a first fiber 161 and a last fiber 163. Ply thickness 164 for each ply 104 may be the same or different depending on design criteria for composite component 100.

Plies 104 are sequentially arranged in a lay-up direction 166 with respect to base surface 102. In the exemplary embodiment, lay-up direction 166 is normal to base surface 102. Alternatively, lay-up direction 166 can be in any orientation with respect to base surface 102. More particularly, first ply 112 is coupled to base surface 102, second ply 114 is coupled to first ply 112, third ply 116 is coupled to second ply 114, fourth ply 118 is coupled to third ply 116, fifth ply 120 is coupled to fourth ply 118, sixth ply 122 is coupled to fifth ply 120, seventh ply 124 is coupled to sixth ply 122, and eighth ply 126 is coupled to seventh ply 124. Plies 112, 114, 116, 118, 120, 122, 124 and 126 are sequenced in an ascending arrangement 167 of decreasing lengths for plies 112, 114, 116, 118, 120, 122, 124, and 126 as referenced from base surface 102.

To enable a step-reduction or incremental change in the overall thickness of composite component 100, at least one ply drop 168 is formed within composite component 100. In the exemplary embodiment, each adjacent ply 104 is configured to form ply drop 168. More particularly, ply drop 168 includes a change in length between adjacent plies 104 of composite component 100. For example, fifth ply 120 includes an end 170, another end 172, and a length 174 extending there between and sixth ply 122 also includes an end 176, another end 178, and a length 180 there between. In the exemplary embodiment, length 180 is different than length 174. More particularly, length 180 is less than length 174. Alternatively, length 180 can be substantially the same or larger than length 174. Based on at least the difference between length 180 and length 174, a ply drop distance 182 is defined between end 172 and end 178.

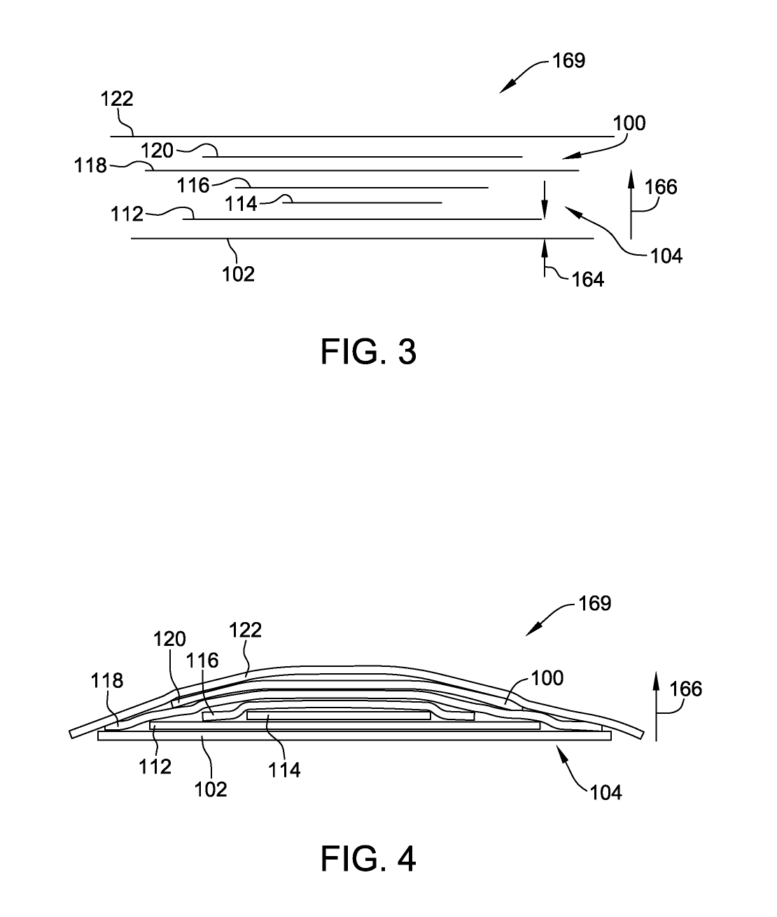

FIG. 3 is a schematic view of another arrangement 169 of the plurality of plies 104 of composite component 100. FIG. 4 is a side elevational view of arrangement 169 (shown in FIG. 3). The composite component 100 includes arrangement 169 of plies 112, 114, 116, 118, 120, and 122. Plies 104 are sequentially arranged in lay-up direction 166 with respect to base surface 102. The lay-up direction 166 is normal to base surface 102. Alternatively, lay-up direction 166 can be in any orientation with respect to base surface 102. More particularly, first ply 112 is coupled to base surface 102, second ply 114 is coupled to first ply 112, third ply 116 is coupled to second ply 114, fourth ply 118 is coupled to third ply 116, fifth ply 120 is coupled to fourth ply 118, and sixth ply 122 is coupled to fifth ply 120. The plies 112, 114, 116, 118, 120, and 122 are sequenced in arrangement 169 that is different than arrangement 167 (shown in FIG. 2). The different lengths of plies 112, 114, 116, 118, 120, and 122 are sequenced with composite component 100 of different lengths for plies 112, 114, 116, 118, 120, and 122. More particularly, plies 112, 114, 114, 116, 118, 120, and 122 are sequenced in arrangement 169 with mixed lengths for plies 112, 114, 114, 116, 118, 120, and 122 disposed throughout component 100 as referenced from base surface 102.

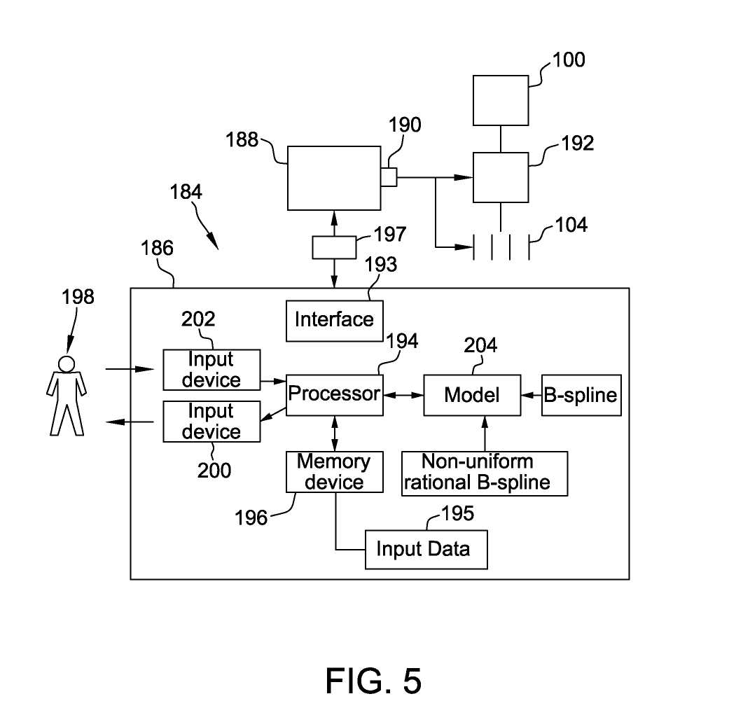

FIG. 5 is a block diagram illustrating a computing system 184 having a computing device 186 for use in computer modeling composite component 100. System 184 includes a lay-up device 188 coupled to computing device 186. The lay-up device 188 includes a tool 190 and a mandrel 192. Computing device 186 includes a processor 194 and a memory device 196 coupled thereto. Processor 194 includes a processing unit, such as, without limitation, an integrated circuit (IC), an application specific integrated circuit (ASIC), a microcomputer, a programmable logic controller (PLC), and/or any other programmable circuit. Processor 194 may include multiple processing units (e.g., in a multi-core configuration). Computing device 186 is configurable to perform the operations described herein by programming processor 194. For example, processor 194 may be programmed by encoding an operation as one or more executable instructions and providing the executable instructions to processor 194 in memory 196. Memory 196 includes, without limitation, one or more random access memory (RAM) devices, one or more storage devices, and/or one or more computer readable media. Memory 196 is configured to store data, such as computer-executable instructions and characteristics, such as configuration characteristics of plies 104. More particularly, configuration characteristic includes, but is not limited to, length, width, height, shape, and/or orientation of plies 104. Memory 196 includes any device allowing information, such as executable instructions and/or other data, to be stored and retrieved.

Stored in memory 196 are, for example, readable instructions for determining at least one of ply drop 168 (shown in FIG. 2), ply drop distance 182 (shown in FIG. 2) and a lay-up sequence of plies 104. Computing device 186 further includes a computer aided design interface 193 may include, among other possibilities, a web browser and/or a client application. Web browsers and client applications enable users 198 to display and interact with media and other information. Exemplary client applications include, without limitation, a software application for managing one or more computing devices 186.

Computing device 186 includes at least one presentation device 200 for presenting information to user 198. Presentation device 200 is any component capable of conveying information to user 198. Presentation device 200 includes, without limitation, a display device (not shown) (e.g., a liquid crystal display (LCD), organic light emitting diode (OLED) display, or “electronic ink” display) and/or an audio output device (e.g., a speaker or headphones). Presentation device 200 includes an output adapter (not shown), such as a video adapter and/or an audio adapter which is operatively coupled to processor 194 and configured to be operatively coupled to an output device (not shown), such as a display device or an audio output device.

Moreover, computing device 186 includes input device 202 for receiving input from user. Input device 202 includes, for example, a keyboard, a pointing device, a mouse, a stylus, a touch sensitive panel (e.g., a touch pad or a touch screen), a gyroscope, an accelerometer, a position detector, and/or an audio input device. A single component, such as a touch screen, may function as both an output device of presentation device 200 and input device 202. Computing device 186 can be communicatively coupled to a network (not shown).

Computing device 186 is configured to use processor 194 to generate a computer model 204 of composite component 100 using, for example only, B-surface representation of plies 104. Computing device 186 is configured to use algorithms, mathematical functions, and/or other mathematical models such as a non-uniform rational B-spline analysis (NURB analysis). Computer model 204 is configured to be used with computer aided design software, in which part geometry is described in terms of features, such as, but not limited to, holes, lines, curves, chamfers, blends, radii, user defined shapes, shapes from shape libraries and characteristics associated with and between these features. The computer model 204 is flexible, in that composite component 100 is described by input data 195 for example characteristics such as length, width, height, shape, material composition, and/or orientation of plies 104 all of which can vary. Processor 194 is configured to alter computer model 204 by changing the value of one or more of characteristics of input data 195. Moreover, computer model 204 applies to an entire part family. Components belonging to a part family differ only with respect to the values of the characteristics describing the parts or with respect to small topological changes, for example different hole sizes or positions corresponding to different machining steps. Computing device 186 is configured to transmit from computer model 204 a manufacturing lay-up sequence 197 to lay-up device 188. Lay-up device 188 is configured to control tool 190 to apply manufacturing processes to plies 104 as plies 104 are coupled to mandrel 192 to facilitate forming composite component 100.

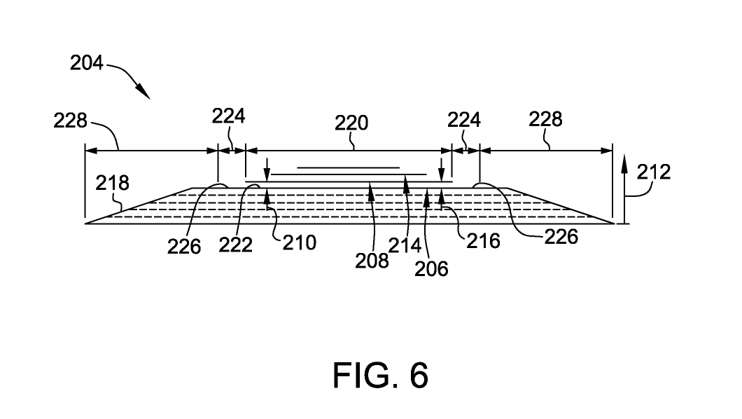

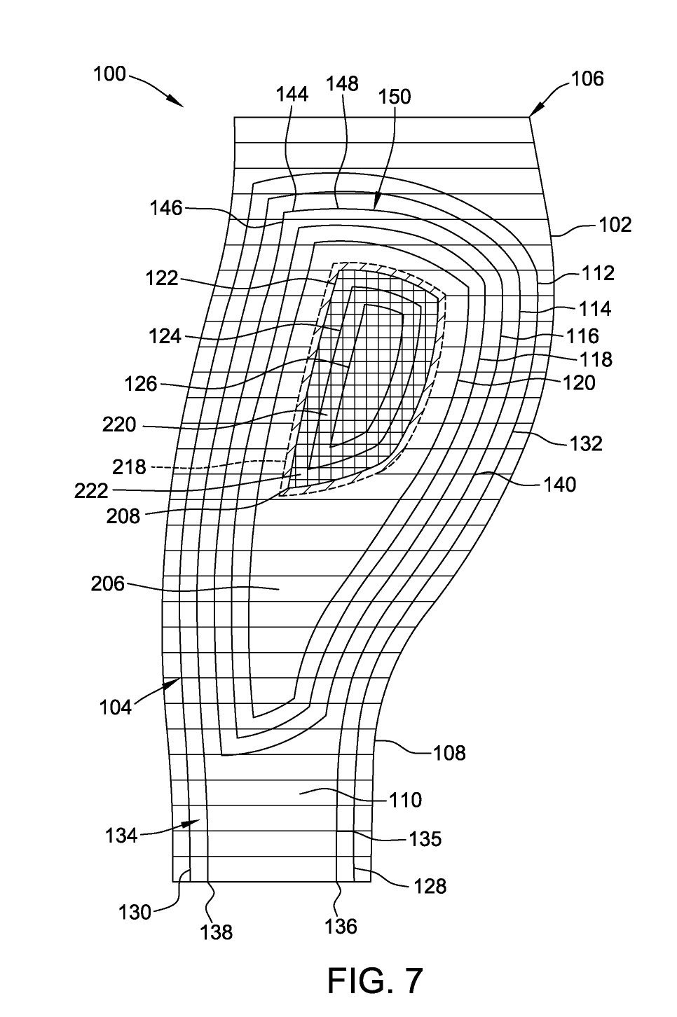

FIG. 6 is a side elevational view of computer model 204 of composite component 100 (shown in FIGS. 1 and 2). FIG. 7 is a plan view of computer model 204 of composite component 100 (shown in FIGS. 1 and 2). Processor 194 (shown in FIG. 5) is configured to receive composite model input data 195 from computer model 204. Processor 194 is configured to generate a base surface 206 which is associated with the largest cross-sectional area of composite component 100 (shown in FIGS. 1 and 2). Processor 194 is also configured to generate a plurality of ply curved surfaces 208 with each ply curved surface 208 having a ply thickness 210 (only shown in FIG. 6). Ply curved surface 208 may include at least one of open curved surface 134 and closed curved surface 150 (both shown in FIG. 1). Moreover, each ply curved surface 208 is associated with a respective ply 104 (shown in FIGS. 1 and 2). Base surface 206 and ply curved surface 208 are pre-defined from known design constraints based on at least one of a previous engineering analysis, a historical analysis, and a look-up table which identifies at least one characteristic of input data 195 of ply 104. Processor 194 is further configured to define a lay-up direction 212 that is normal to base surface 206. Each ply curved surface 208 is projected in a sequential sequence 214 (only shown in FIG. 6) with respect to lay-up direction 212. Although ply curved surfaces 208 are illustrated in an ascending arrangement of decreasing length as referenced from base surface 206, curved surfaces 208 may be sequenced in any order with any lengths.

Processor 194 is configured to calculate a ply drop distance 216 between ply curved surface 208 and base surface 206. Moreover, processor 194 is configured to offset ply curved surface 208 outwardly from and along base surface 206. Ply curved surface 208 is offset by processor 194 to facilitate defining an offset ply curved surface 218. A ply region 220 is calculated by processor 194. Ply region 220 includes a portion of an area 222 of base surface 206 that is interior of ply curved surface 208. Moreover, a ply drop region 224 of base surface 206 is defined by processor 194. Ply drop region 224 includes an area 226 of base surface 206 that is external of ply curved surface 208 and interior of offset ply curved surface 218. Still further, processor 194 is configured to define an outer region 228.

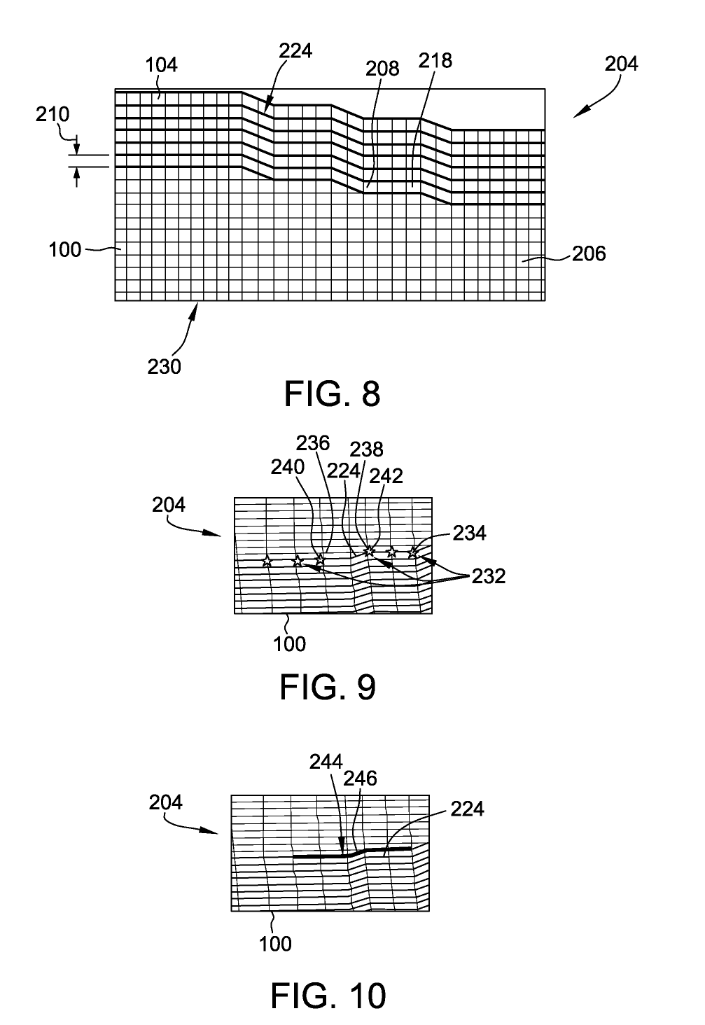

FIG. 8 is a schematic view of computer model 204 and discretized ply drop regions 224 of composite component 100. Processor 194 (shown in FIG. 5) is configured to generate a surface mesh 230 of plies 104 based at least on offset ply curved surface 218 and ply drop region 224. More particularly, surface mesh 230 includes base surface 206, ply curved surface 208, and respective ply thicknesses 210 of plies 104. In the exemplary embodiment, surface mesh 230 includes discretized ply drop regions 224.

FIG. 9 is another schematic view of computer model 204 of composite component 100 and a plurality of node points 234 applied to discretized ply drop regions 224. FIG. 10 is yet another schematic view of computer model 204 of composite component 100 and a curved function 244 applied to the plurality of node points 234. In the exemplary embodiment, processor 194 (shown in FIG. 5) is configured to generate node data 232 (only shown n FIG. 9) associated with ply drop region 224. Node data 232 includes a plurality of node points 234 relative to a first side 236 (both only shown in FIG. 9) of ply drop region 224 and relative to a second side 238 (only shown in FIG. 9) of ply drop region 224. More particularly, processor 194 is configured to position a first set 240 of node points 234 adjacent to first side 236 and a second set 242 (only shown in FIG. 9) of node points 234 adjacent to second side 238.

Processor 194 is configured to apply curved function 244 (only shown in FIG. 10) to the plurality of node points 234. In the exemplary embodiment, curved function 244 is a 3^{rd} order cubic curved function 244. Alternatively, curved function 244 may include any mathematical function order to enable processor 194 to function as described herein. Curved function 244 is configured to facilitate forming a smoothed node data 246 (only shown in FIG. 10) across ply drop region 224. More particularly, curved function 244 is configured to adjust the plurality of node points 234 to curvilinear function 244 between first side 236 and second side 238 to smooth and/or de-discretize ply drop region 224.

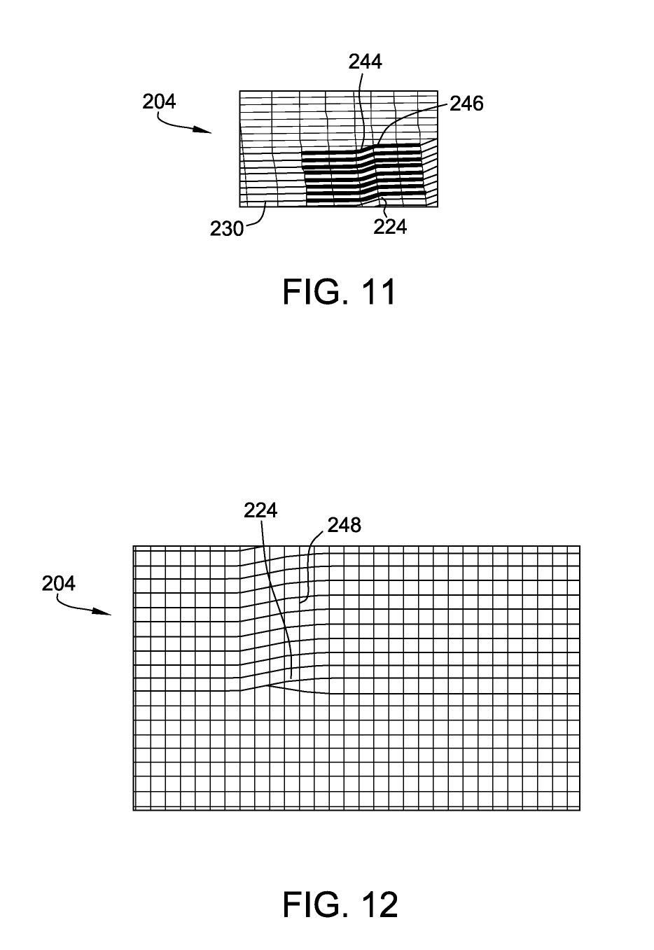

FIG. 11 is another schematic view of computer model 204 and curved function 244 propagated through ply drop regions 224. FIG. 12 is another schematic view of computer model 204 and a generated ply mesh 248 (only shown in FIG. 12). Processor 194 (shown in FIG. 5) is configured to repeatedly and/or selectively apply curved function 244 to subsequent ply drop regions 224 to facilitate propagating smoothed node data 246 (only shown in FIG. 11) through a thickness of composite component 100. Processor 194 is further configured to generate ply mesh 248 using smoothed node data 246 and surface mesh 230. In the exemplary embodiment, ply mesh 248 includes a three-dimensional mesh through a thickness of computer model 204 of composite component 100. Processor 194 is further configured to generate manufacturing lay-up sequence 197 (shown in FIG. 5) for the plurality of plies 104 based on ply mesh 248. In the exemplary embodiment, processor 194 is configured to smooth out and/or adjust ply drop regions 224 to reduce and/or eliminate artificially introduced high stress concentration areas during the design modeling stage of composite component 100. Moreover, processor 194 is configured to apply adaptive meshing techniques such as applying curved function 244 to optimize the amount of node points 234 (shown in FIG. 9) and the size of ply mesh 248 to facilitate obtaining enhanced computation performance. Ply mesh 248 further provides a detailed and accurate prediction of a failure mode of composite component 100 to improve fidelity of the failure analysis while reducing design cycle time during modeling stages.

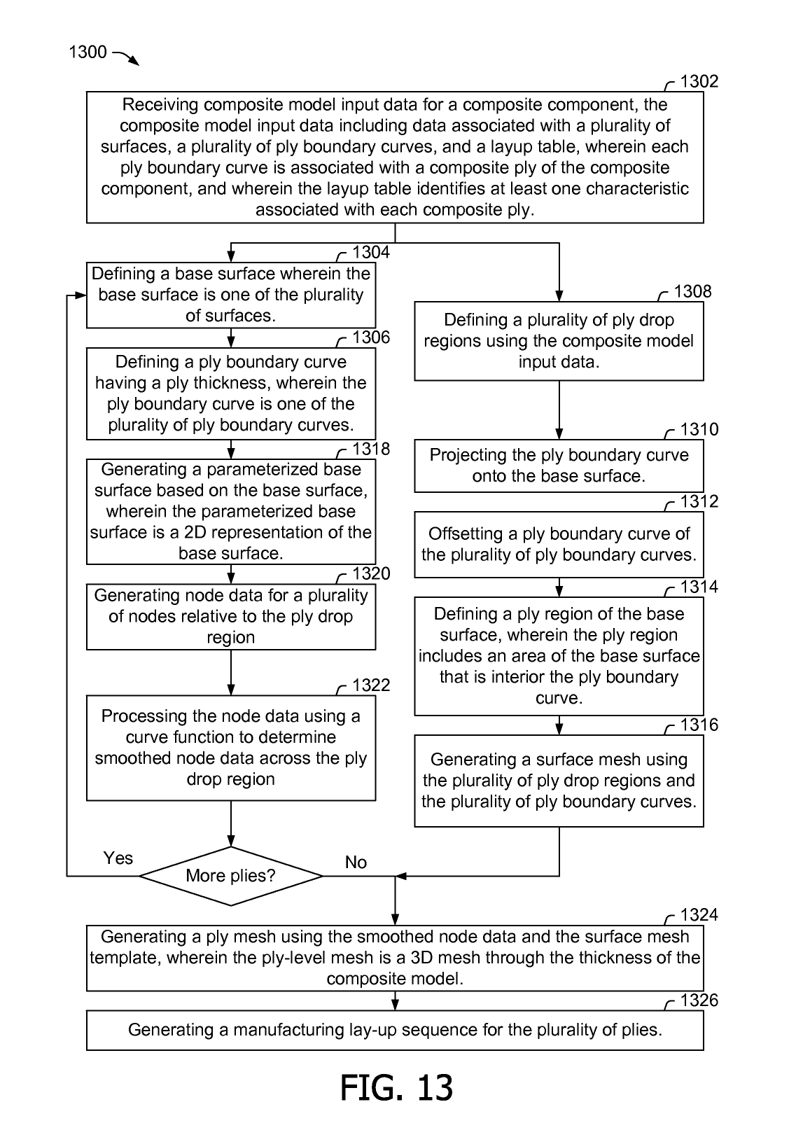

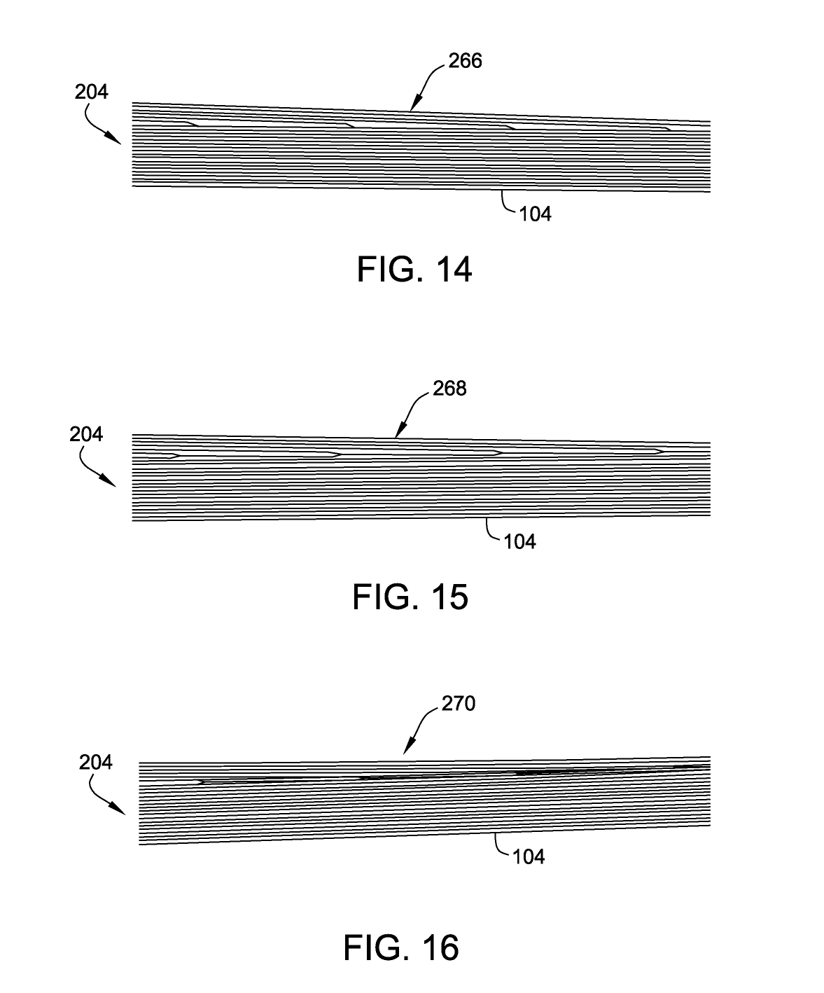

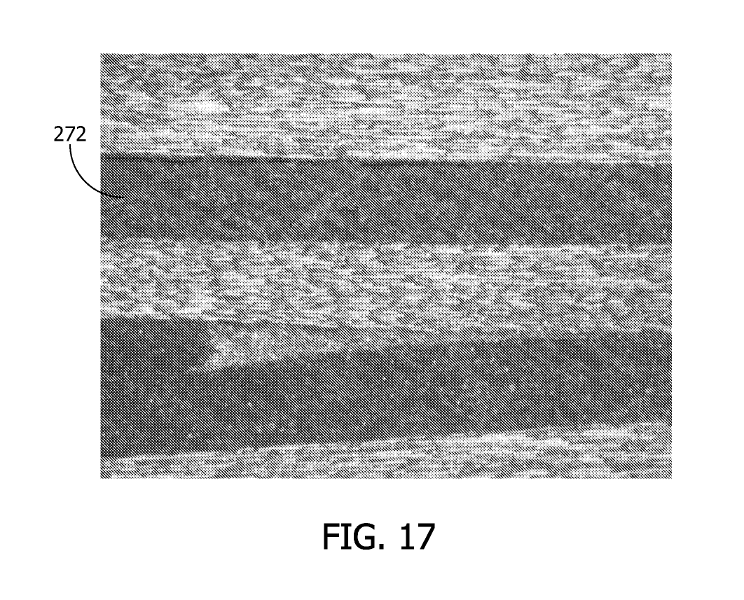

FIG. 13 is a flowchart illustrating an exemplary computer implemented method 1300 for generating computer model 204 (shown in FIG. 8) of composite component 100 (shown in FIG. 1) by computing system 184 (shown in FIG. 5). FIG. 14 is a schematic view of computer model 204 of a lay-up arrangement 266 (only shown in FIG. 14) of the plurality of plies 104. FIG. 15 is another schematic view of computer model 204 of a processed arrangement 268 (only shown in FIG. 15) the plurality of plies 104 subsequent a cure process (not shown). FIG. 16 is a schematic view of an overlay arrangement 270 (only shown in FIG. 16) of computer model 204. FIG. 17 is a cross sectional view of a composite component 272 (only shown in FIG. 17) formed by manufacturing lay-up sequence 197 (shown in FIG. 5). Method 1300 is configured to facilitate representation of physical ply behaviors of ply drop regions 224 (shown in FIG. 6). More particularly, method 1300 is configured to change and/or adjust a cross section of composite component 100 as compared to lay-up arrangement 266 and processed arrangement 268 of the plurality of plies 104.

Method 1300 includes receiving 1302 composite model input data 195 (shown in FIG. 5) for composite component 100. In the exemplary method 1300, composite model input data 195 includes characteristics associated with at least one of surfaces, ply curved surfaces, and lay-up table. Method 1300 includes defining 1304 base surface 206 (shown in FIG. 4), in a three-dimensional model, for example model 204 (shown in FIG. 5). Alternatively, the base surface may include a base curve (not shown) in a two-dimensional model. In the exemplary method 1300, the base surface is defined and/or derived from at least one of predetermined and/or known design constraints, previous engineering analysis, historical analysis, and a look-up table. Ply curved surface 208 (shown in FIG. 6) is defined 1306 and includes ply thickness 210 (shown in FIG. 6). In the exemplary method 1300, the ply curved surface is defined along lay-up direction 212 (shown in FIG. 56). Moreover, in the exemplary method 1300, the ply curved surface is associated with at least one of plies 104 (shown in FIGS. 1 and 2). Method 1300 also includes defining 1308 a plurality of ply drop regions 224 (shown in FIG. 6). Method 1300 includes projecting 1310 the ply curve 208 onto base surface 206. In the exemplary method 1300, ply boundary curve 208 is defined and/or derived from at least one of predetermined and/or known design constraints, previous engineering analysis, historical analysis, and a look-up table.

Method 1300 includes offsetting 1312 the projected ply curved surface outwardly from and from the base surface to define offset ply curved surface 218 (shown in FIG. 6). In the exemplary method, ply drop region 224 includes area 226 (shown in FIG. 6) that is exterior ply curve 208 and interior offset ply boundary curve 218. Moreover, method 1300 includes defining 1314 ply region 220 (shown in FIG. 6). Ply region 220 includes area 222 (shown in FIG. 6) that is interior the offset ply boundary curve surface (218).

Surface mesh 230 (shown in FIG. 8) is generated 1316 based at least on ply drop region 224 and ply boundary curve 208. Method 1300 includes generating 1318 characterized node points 234 relative to base surface 206. In the exemplary embodiment, the characterized base surface is a two dimensional representation of base surface 206. Node data 232 (shown in FIG. 9), which includes plurality of node points 234 (shown in FIG. 9), is generated 1320 relative to ply drop region 224. Method 1300 includes processing node data 232 by applying 1322 curved function 244 (shown in FIG. 9) to plurality of node points 234 to facilitate forming smoothed node data 246 (shown in FIG. 10) across ply drop region 224. Method 1300 further includes generating 1324 ply mesh 248 using smoothed node 246 data and mesh surface #. The ply mesh is a three dimensional mesh formed by at least one of extrusion, revolution, and sweeping through a thickness of computer model of composite component 100. Moreover, method 1300 includes generating 1326 manufacturing lay-up sequence 197 (shown in FIG. 5) for plurality of plies # based on ply mesh 248.

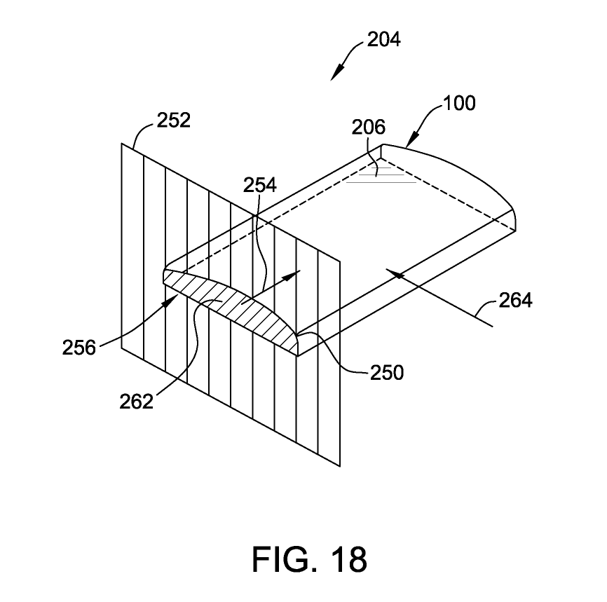

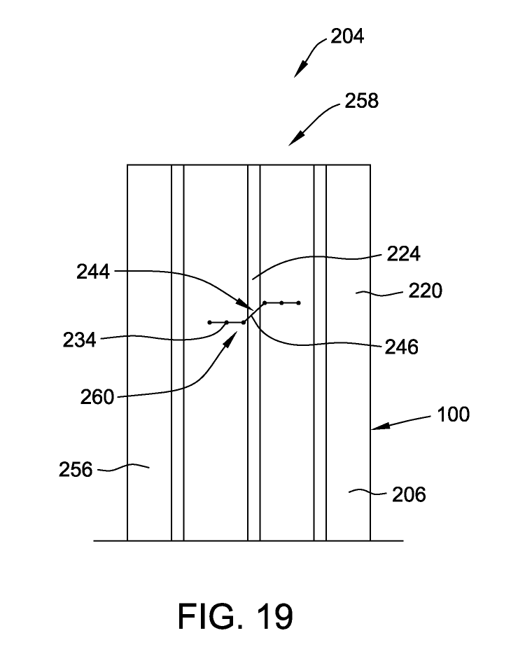

FIG. 18 is a perspective view of computer model 204 for a cross section of composite component 100 (shown in FIG. 14). FIG. 19 is a planar view of computer model 204 and composite component 100. In the exemplary embodiment where composite component 100 includes a symmetrical cross section 250 on a plane of symmetry 252 and in an extrusion direction 254, processor 194 (shown in FIG. 5) is configured to apply curved function 244 to a two-dimensional surface 256 which may include a two-dimensional surface through thickness of ply drop region 224 and other three-dimensional information. Applying curved function 244 to two-dimensional surface 256 reduces computing time, calculations, and cost.

In the exemplary embodiment, processor 194 is configured to define symmetrical cross section 250 on plane of symmetry 252. Processor 194 is configured to generate a surface mesh template 258 based on ply region 220 and ply drop region 224. Moreover, processor 194 is configured to generate two-dimensional surface 256 relative to base surface 206. Still further, processor 194 is configured to define a mesh element 260 having the plurality of node points 234 relative to ply region 220 and ply drop region 224.

Processor 194 is configured to apply curved function 244 to plurality of node points 234 to facilitate forming smoothed node data 246 across ply drop region 224 and along symmetrical cross section 250. Moreover, processor 194 is configured to generate a smoothed cross section mesh 262 by applying curved function 244 through a thickness of composite component 100. In the exemplary embodiment, processor 194 is configured to generate a three-dimensional mesh 264 by manipulating, such as, but not limited to, extruding, swinging, and revolving smoothed cross section mesh 262.

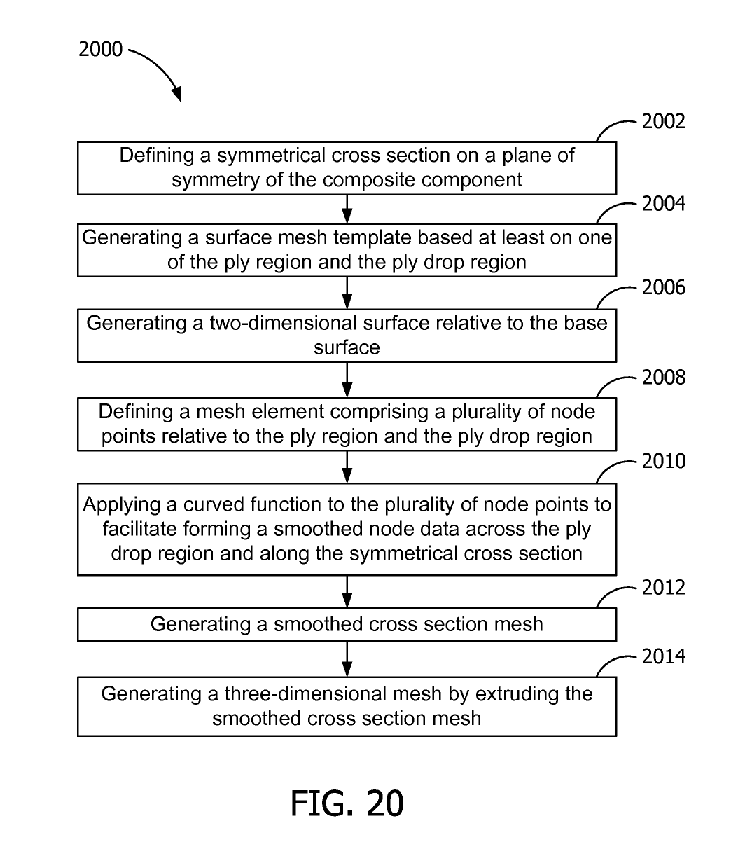

FIG. 20 is a flowchart illustrating an exemplary computer implemented method 2000 of generating computer model 204 of composite component 100 having base surface 206, ply region 220 and ply drop region 224 (all shown in FIG. 9). Method 2000 includes defining 2002 symmetrical cross section 250 on plane of symmetry 252 (shown in FIG. 18) of the computer model. Method 2000 includes generating 2004 surface mesh template 258 (shown in FIG. 19) based at least on one of the ply region and the ply drop region. Moreover, method 2000 includes generating 2006 two-dimensional surface 256 (shown in FIG. 18) relative to base surface 206. In the exemplary method 2000, mesh element 260 (shown in FIG. 19) is defined 2008 having plurality of node points 234 (shown in FIG. 19) relative to ply drop region 224 and ply drop region 224. Method 2000 includes applying 2010 curved function 244 (shown in FIG. 19) to facilitate forming smoothed node data 246 (shown in FIG. 19) across ply drop region 224. Moreover, method 2000 includes applying curved function 224 along symmetric cross section 250 using surface mesh template 258 to facilitate generating 2012 smoothed cross section mesh 262 (shown in FIG. 19). In the exemplary method 2000, three-dimensional mesh 264 (shown in FIG. 19) is generated 2014 by manipulating such as, but not limited to, extruding, swinging, and revolving smoothed cross section mesh 262.

The exemplary embodiments described herein facilitate increasing efficiency and reducing costs for generating a computer model of a composite component. More particularly, the exemplary embodiments described herein facilitate generating a computer model for enhanced designs of a ply mesh for a lay-up sequence of a plurality of plies to form the composite component. More particularly, the exemplary embodiments described herein are configured to generate a computer model for three dimensional ply curved surfaces, either open curved surfaces or closed curved surfaces, for a lay-up sequence of plies on a tooling surface. Moreover, the embodiments described herein apply a curved function to facilitate forming a ply mesh. More particularly, the high fidelity analysis is configured to accurately locate high stress/shear locations positioned within composite component and to prevent introducing high stress concentrations during development of the computer model. The embodiments described herein can be used for direct 3D solid element generation and/or 3D layered/piled shell geometries.

A technical effect of the systems and methods described herein includes at least one of: (a) generating a computer model of a composite component; (b) accounting for ply drop regions during a computer modeling stage of the composite component; (c) iteratively improving a computer aided design process by a computer model; (d) applying a smoothing algorithm to facilitate forming a ply mesh; (e) providing a prediction for a failure mode of the composite component; and (f) increasing efficiency and decreasing costs for computer modeling of components.

Processor is not limited to just those integrated circuits referred to in the art as a computer, but broadly refers to a microcontroller, a microcomputer, a programmable logic controller (PLC), an application specific integrated circuit, and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc—read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor. The above examples are exemplary only, and thus are not intended to limit in any way the definition and/or meaning of the term processor.

Exemplary embodiments of a computing device and computer implemented methods for generating a computer model of a composite component. The methods and systems are not limited to the specific embodiments described herein, but rather, components of systems and/or steps of the methods may be utilized independently and separately from other components and/or steps described herein. For example, the methods may also be used in combination with other manufacturing systems and methods, and are not limited to practice with only the systems and methods as described herein. Rather, the exemplary embodiment may be implemented and utilized in connection with many other composite laminate applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method for generating a computer model of a composite component using a computing device including at least one processor coupled to a memory device, the composite component having a predefined base surface and a predefined ply curved surface formed by a ply of a plurality of composite plies, each ply of the plurality of composite plies having a ply thickness, said method comprising:
offsetting the projected ply curved surface outwardly from the base surface to define an offset ply curved surface;
defining a ply region of the base surface, wherein the ply region includes an area of the base surface that is interior to the ply curved surface;
defining a ply drop region of the base surface, wherein the ply drop region includes another area of the base surface that is exterior to the ply curved surface and interior to the offset ply curved surface;
generating a surface mesh based on the ply drop region and the ply curved surface;
generating node data including a plurality of node points relative to the ply drop regions;
applying a curved function to the plurality of node points to facilitate forming a smoothed node data across the ply drop region; and
generating a ply mesh using the smoothed node data and the surface mesh.

2. The method of claim 1, wherein applying a curved function comprises adjusting the plurality of node points relative to the ply drop region.

3. The method of claim 1, wherein applying a curved function comprises applying a 3^{rd} order curved function.

4. The method of claim 1, wherein generating node data comprises generating a first set of node points positioned adjacent a first side of the ply drop region.

5. The method of claim 4, wherein generating node data comprises generating a second set of node points positioned adjacent a second side of the ply drop region.

6. The method of claim 1, wherein generating a ply mesh comprises generating a three-dimensional mesh through a thickness of the computer model of the composite component.

7. The method of claim 1 further comprising generating a manufacturing lay-up sequence for the ply mesh.

8. The computer implemented method of claim 1 further comprising defining the base surface in a three-dimensional model.

9. The computer implemented method of claim 1 further comprising defining the base surface in a two-dimensional model.

10. The method of claim 1 further comprising projecting the ply curved surface onto the base surface.

11. A computing device for generating a computer model of a composite component, the composite component including base surface, a ply curved surface, and plurality of composite plies, said computing device comprising:
a memory device configured to store a characteristic of the composite component;
an interface coupled to said memory device and configured to receive said characteristic of the composite component; and
a processor coupled to said memory device and said interface device, said processor configured to:
offset the projected ply curved surface outwardly from the base surface to define an offset ply curved surface;
define a ply region of the base surface, wherein the ply region includes an area of the base surface that is interior to the ply curved surface;
define a ply drop region of the base surface, wherein the ply drop region includes another area of the base surface that is exterior to the ply curved surface and interior to the offset ply curved surface;
generate a surface mesh based on the ply drop region and the ply curved surface;
generate a node data including a plurality of node points relative to the ply drop regions;
apply a curved function to the plurality of node points to facilitate forming a smoothed node data across the ply drop region; and
generate a ply mesh using the smoothed node data and the surface mesh.

12. The computer device of claim 11, wherein the ply curved surface includes at least one of a closed curve and an open curve.

13. The computer device of claim 11, wherein the curved surface includes at least one of a B-spline generated curve and a non-uniform rational B-spline generated curve.

14. The computer device of claim 11, wherein said processor is configured to generate a surface mesh based on the ply drop region and the ply curved surface.

15. The computer device of claim 11, wherein the curved function is configured to adjust the plurality of node points relative to the ply drop region.

16. The computer device of claim 11, wherein the curved function includes a 3^{rd} order curved function through the plurality of node points.

17. The computer device of claim 11, wherein the plurality of node points comprises a first set of node points positioned adjacent a first side of the ply drop region and a second set of node points positioned adjacent a second side of the ply drop region.

18. One or more non-transitory computer-readable storage media having computer-executable instructions embodied thereon for generating a computer model of a composite component, the composite component having a base surface, a ply curved surface, and a plurality of composite plies using a computer having a memory device and a processor, wherein when executed by said processor, said computer-executable instructions cause the processor to:
offset the projected ply curved surface outwardly from the base surface to define an offset ply curved surface;
define a ply region of the base surface, wherein the ply region includes an area of the base surface that is interior to the ply curved surface;
define a ply drop region of the base surface, wherein the ply drop region includes another area of the base surface that is exterior to the ply curved surface and interior to the offset ply curved surface;
generate a surface mesh based on the ply drop region and the ply curved surface;
generate node data including a plurality of node points relative to the ply drop regions;
apply a curved function to the plurality of node points to facilitate forming a smoothed node data across the ply drop region; and
generate a ply mesh using the smoothed node data and the surface mesh.

19. The one or more non-transitory computer-readable storage media of claim 18, wherein the computer executable instructions further cause the processor to apply the curved function to adjust the plurality of node points relative to the ply drop region.

20. The one or more non-transitory computer-readable storage media of claim 18, wherein the computer executable instructions further cause the processor to apply a 3^{rd} order curved function through the plurality of node points.

21. A method for generating a computer model of a composite component including a predefined base surface, a ply region, and a ply drop region, said method comprising:
defining a symmetrical cross section on a plane of symmetry of the composite component;
generating a surface mesh template based at least on one of the ply region and the ply drop region;
generating a two-dimensional surface relative to the base surface;
defining a mesh element including a plurality of node points relative to the ply region and the ply drop region;
applying a curved function to the plurality of node points to facilitate forming a smoothed node data across the ply drop region and along the symmetrical cross section;
generating a smoothed cross section mesh; and
generating a three-dimensional mesh by extruding the smoothed cross section mesh.

22. The method of claim 21, wherein generating the smoothed cross section comprises applying the curved function through a thickness of the composite component.
